(19) United States
(12) Patent Application Publication
(10) Pub. No.: US 2018/0320916 A1
(43) Pub. Date: Nov. 8, 2018

(54) HVAC MANAGEMENT SYSTEM AND METHOD

(71) Applicant: CARRIER CORPORATION, Palm Beach Gardens, FL (US)

(72) Inventors: Antonio M. Vincitore, South Windsor, CT (US); Nicholas Charles Soldner, Southbury, CT (US); Sanjay Bajekal, Simsbury, CT (US)

(21) Appl. No.: 15/770,982

(22) PCT Filed: Oct. 21, 2016
(86) PCT No.: PCT/US2016/058046

§ 371 Date: Apr. 25, 2018

Related U.S. Application Data
(60) Provisional application No. 62/250,636, filed on Nov. 4, 2015.

(51) Int. Cl. F24F 11/46; F24F 11/58; G05D 23/19

(52) U.S. Cl. CPC F24F 11/46; F24F 2110/70; G05D 23/1931; F24F 11/58

(57) ABSTRACT

A HVAC management system includes a space having an atmospheric condition to be controlled. Also included are air manipulation components to alter the atmospheric condition of the space. Further included is a sensor assembly located proximate the space for approximating a number of occupants present in the space based on a number of mobile devices located within the space. The sensor assembly includes a receiver capable of detecting communication data associated with a mobile device. The HVAC management system yet further includes a controller in operative communication with the air manipulation components and the sensor assembly, the controller receiving information from the sensor assembly comprising temperature data and the number of mobile devices, the controller controlling the air manipulation components based on the information received from the sensor assembly.

### BACKGROUND OF THE DISCLOSURE

The embodiments herein generally relate to heating, ventilation and air conditioning (HVAC) systems and, more particularly, to a management system for HVAC systems, as well as a method of managing HVAC systems.

HVAC systems are used to meet occupant comfort and ventilation needs within a building space. Typically this involves the conditioning of air circulated to and from the space served via an air handler of some form, e.g., fans and blowers. Conditioning the air can include any combination of heating, cooling, filtering, humidifying, and dehumidifying air in a defined building space. Additionally, most HVAC systems have provision for supplying minimum amounts of fresh outside air to ensure proper ventilation for human occupants.

HVAC systems typically involve a room thermostat controlling the heating, cooling, and ventilation modes based on whether the space is occupied and the programmed heating and cooling set points. Changes in space temperature result in the thermostat sending commands to heat or cool the air being supplied to the space as necessary. The total amount of energy required to heat or mechanically cool the air is impacted by the temperature of the outside air entering the system. The colder the outside air is relative to the space, the greater the amount of energy required to heat the air. The hotter the outside air is relative to the space, the greater the amount of energy required to cool the air.

In many HVAC systems, the amount of outside air supplied to the space for ventilation is set for the maximum number of potential occupants anticipated in the space. However, the space often has fewer occupants than the maximum number and the result is an over-ventilated space. As stated previously, there is an energy cost associated with heating or cooling outside air, thereby resulting in inefficiencies and undesirable costs.

### BRIEF DESCRIPTION OF THE DISCLOSURE

According to one embodiment, a heating, ventilation and air conditioning (HVAC) management system is provided and includes a space having an atmospheric condition to be controlled. Also included is a plurality of air manipulation components to alter the atmospheric condition of the space. Further included is a sensor assembly located proximate the space for approximating a number of occupants present in the space based on a number of mobile devices located within the space. The sensor assembly includes a receiver capable of detecting communication data associated with a mobile device. The HVAC management system yet further includes a controller in operative communication with the plurality of air manipulation components and the sensor assembly, the controller receiving information from the sensor assembly comprising temperature data and the number of mobile devices, the controller controlling the plurality of air manipulation components based on the information received from the sensor assembly.

In addition to one or more of the features described above, or as an alternative, further embodiments may include that the mobile devices are cellular phones.

In addition to one or more of the features described above, or as an alternative, further embodiments may include that the sensor assembly is plugged into a power outlet of the space.

In addition to one or more of the features described above, or as an alternative, further embodiments may include that the sensor assembly is in wired connection with the controller via the power outlet.

In addition to one or more of the features described above, or as an alternative, further embodiments may include that the sensor assembly is in wireless connection with the controller.

In addition to one or more of the features described above, or as an alternative, further embodiments may include that the sensor assembly further comprises an antenna operatively coupled to the receiver.

In addition to one or more of the features described above, or as an alternative, further embodiments may include that the receiver comprises a GSM (global system for mobile communications) receiver.

In addition to one or more of the features described above, or as an alternative, further embodiments may include that the sensor assembly is Wi-Fi enabled to detect the mobile devices.

In addition to one or more of the features described above, or as an alternative, further embodiments may include that the sensor assembly is Bluetooth enabled to detect the mobile devices.

In addition to one or more of the features described above, or as an alternative, further embodiments may include that the sensor assembly further comprises at least one additional occupancy detection component for detection based on at least one of light sensing, carbon dioxide sensing, vibration sensing, indoor air quality sensing, toxic gas sensing and smoke sensing.

According to another embodiment, a method of managing a heating, ventilation and air conditioning (HVAC) system is provided. The method includes controlling an atmospheric condition of a space with a plurality of air manipulation components. The method also includes approximating a number of occupants present in the space based on a number of mobile devices located within the space with a sensor assembly, wherein approximating the number of occupants comprises detecting communication data associated with a mobile device with a receiver of the sensor assembly. The method further includes measuring a temperature of an area of the space proximate the sensor assembly with a temperature sensor of the sensor assembly. The method yet further includes sending data comprising the temperature measured and the number of mobile devices from the sensor assembly to a controller in operative communication with the sensor assembly and the plurality of air manipulation components. The method also includes controlling the plurality of air manipulation components with the controller based on the data received from the sensor assembly.

In addition to one or more of the features described above, or as an alternative, further embodiments may include that the sensor assembly is in wired communication with the controller.

In addition to one or more of the features described above, or as an alternative, further embodiments may include that the sensor assembly is plugged into a power outlet of the space to establish the wired communication.

In addition to one or more of the features described above, or as an alternative, further embodiments may include that the sensor assembly is in wireless communication with the controller.

In addition to one or more of the features described above, or as an alternative, further embodiments may include that the receiver comprises a GSM (global system for mobile communication) receiver.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 is a schematic illustration of an HVAC management system associated with a space; and

FIG. 2 is an enlarged view of a sensor assembly of the HVAC management system.

### DETAILED DESCRIPTION OF THE DISCLOSURE

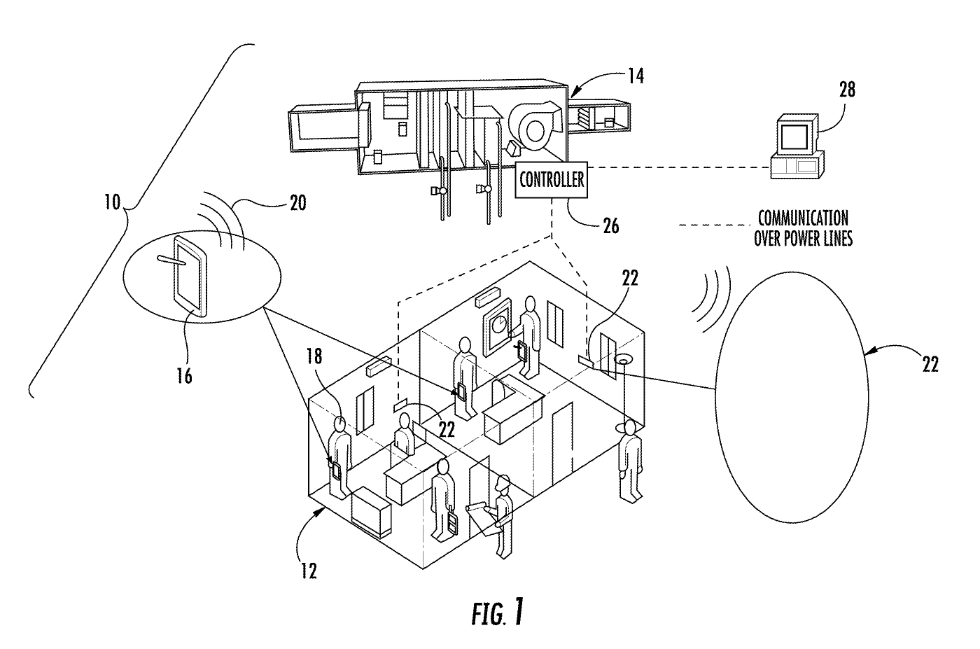

Referring to FIG. 1, a heating, ventilation and air conditioning (HVAC) management system is schematically illustrated and generally referenced with numeral 10. The HVAC management system 10 is employed to adjust at least one atmospheric condition within a space 12. In the illustrated embodiment, the space 12 is a single room of a building, but it is to be appreciated that the space may comprise multiple rooms in any conceivable arrangement. This includes residential dwellings, office buildings, factories, etc. These are merely illustrative examples and are not limiting of the type of structures within which the space 12 may be present.

The at least one atmospheric condition referenced above relates to the control and regulation of temperature and/or humidity, for example. In the context of temperature, the number of occupants of the space 12 impacts the air and energy requirements of the HVAC management system 10. In other words, as more occupants are present in the space 12, more energy is required to cool the space based on body heat emitted by human beings. Conversely, the energy requirement decreases as the number of occupants is lessened during a cooling operation of the HVAC management system 10. The atmospheric condition control is physically facilitated by operation of a plurality of air manipulation components 14 that move and condition air. These components include fans and heat exchangers, for example.

As shown in FIG. 1, a number of occupants 18 are located in the space 12, with most of the occupants 18 each carrying a mobile device 16. In one embodiment, the mobile device 16 is a cellular phone, however, other mobile devices are contemplated. It is understood that most individuals in many parts of the world now carry mobile devices, such as cellular phones, that emit communication data, as represented with numeral 20. Therefore, a reliable approximation of the number of occupants 18 in the space 12 may be made by counting the number of mobile devices present in the space 12. The communication data emitted 20 by the mobile devices 16 is necessary for many operations of the devices, with such communications including radio frequency emissions.

The communication data emitted 20 by the mobile devices 16 is detected 21 by at least one sensor assembly 22 located proximate the space 12. As shown, a plurality of sensor assemblies 22 may be present. The sensor assembly 22 is located within the space 12 in the illustrated embodiment, but it is contemplated that the sensor assembly 22 is located just outside of the space 12. In some embodiments, the sensor assembly 22 is plugged directly into an existing power outlet of the space. In such embodiments, the sensor assembly 22 is powered by available AC power and is in wired communication (e.g., connection) with a controller 26. However, it is contemplated that a wireless connection is made between the sensor assembly 22 and the controller 26.

The controller 26 is in operative communication with the plurality of air manipulation components 14 to control the operation of the air manipulation components 14. The controller 26 is configured to receive, process and transmit data to effect operation of the air manipulation components 14 in a manner that produces a desired atmospheric condition within the space 12. The controller 26 may be a standalone unit or may be part of a larger system, such as the illustrated energy management system 28.

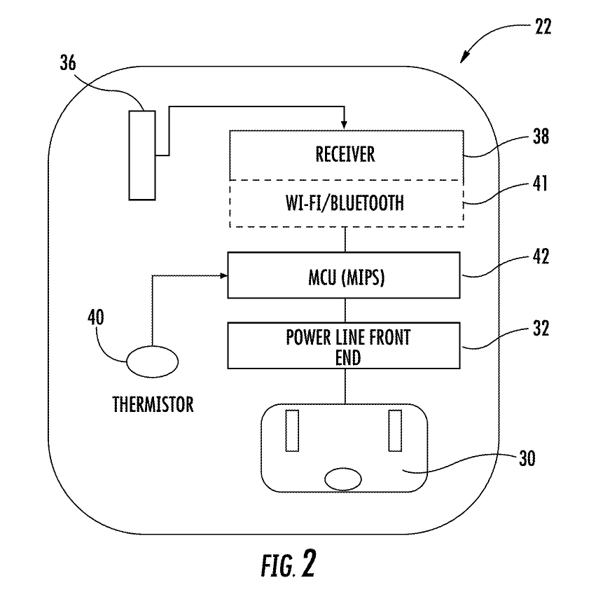

Referring now to FIG. 2, the sensor assembly 22 is illustrated in greater detail. As described above, the sensor assembly 22 is plugged directly into a power outlet in some embodiments. A plug 30 is shown and a power line front end 32 of a wired connection between the sensor assembly 22 and the controller 26 is schematically represented. The sensor assembly 22 includes an antenna 36 operatively coupled to a receiver 38 that together detect the communication data 20 emitted by mobile devices 16 within the space 12. In some embodiments, the receiver 38 is a global system for mobile communications (GSM) receiver. In operation, the receiver 38 scans for communication data emissions 20 and other RF power bursts related to the operation of a mobile device (e.g., cellular phone). The detected data is communicated to the controller 26 for processing therein. The controller 26 calculates the number of detected mobile devices and this calculation is used as a reliable approximation of the number of individuals present in the space 12. As discussed in detail above, the number of individuals present in the space 12 impacts the energy requirements of the air manipulation components 14 to provide a desired atmospheric condition (e.g., temperature).

In some embodiments, the sensor assembly 22 is Wi-Fi and/or Bluetooth enabled through the use of one or more communication components 41 in a manner that allows for detection of Bluetooth and/or Wi-Fi connectivity of the mobile devices 16 with the installation of an app on the mobile device 16. Wi-Fi and/or Bluetooth detection may be used as an alternative manner of mobile device detection or used in combination with the receiver (e.g., GSM receiver) 38 method described above in detail.

In some embodiments, the sensor assembly 22 also includes a temperature sensor 40, such as a thermistor. The temperature sensor 40 measures local temperature in the area of the space 12 that the sensor assembly 22 is disposed.

The data collected by the receiver 38, the temperature sensor 40 and/or the Wi-Fi and/or Bluetooth enabling components 41 are compiled in a microcontroller unit (MCU) 42 and then communicated to the controller 26. The controller 26 is programmed with embedded controls (e.g., schedules) based on the mobile device counts, temperature, and any other desired and known variable, to more efficiently and effectively manage the plurality of air manipulation components 14.

The sensor assembly 22 may also include additional occupancy detection components for detecting the number of occupants located within the space 12. For example, the components may detect occupants based on light sensing, carbon dioxide level sensing, vibration sensing, indoor air quality sensing, toxic gas sensing, and/or smoke sensing. These are merely illustrative examples of the types of additional detection components and are not limiting.

Advantageously, the HVAC management system 10 and, more particularly, the sensor assembly 22 provide enhanced functionality and occupant feedback when compared to conventional motion sensors or image based sensors. In particular, by implementing the sensor assembly 22 into the HVAC management system 10, data obtained by the sensor assembly 22 (e.g., counting occupants) provides more accurate and efficient control the HVAC components. The sensor assembly 22 does not require processing to be done therein, with the controller 26 of the HVAC management system 10 handling processing. Additionally, the sensor assembly 22 may be plugged directly into the existing power structure of the space 12, such that a direct wired connection is available between the sensor assembly and the controller 26, thereby eliminating the need for a more complex wireless communication scheme between the components.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

1. A heating, ventilation and air conditioning (HVAC) management system comprising:
a space having an atmospheric condition to be controlled;
a plurality of air manipulation components to alter the atmospheric condition of the space;
a sensor assembly located proximate the space for approximating a number of occupants present in the space based on a number of mobile devices located within the space, the sensor assembly comprising a receiver capable of detecting communication data associated with a mobile device; and
a controller in operative communication with the plurality of air manipulation components and the sensor assembly, the controller receiving information from the sensor assembly comprising temperature data and the number of mobile devices, the controller controlling the plurality of air manipulation components based on the information received from the sensor assembly.

2. The HVAC management system of claim 1, wherein the mobile devices are cellular phones.

3. The HVAC management system of claim 1, wherein the sensor assembly is plugged into a power outlet of the space.

4. The HVAC management system of claim 3, wherein the sensor assembly is in wired connection with the controller via the power outlet.

5. The HVAC management system of claim 1, wherein the sensor assembly is in wireless connection with the controller.

6. The HVAC management system of claim 1, wherein the sensor assembly further comprises an antenna operatively coupled to the receiver.

7. The HVAC management system of claim 1, wherein the receiver comprises a GSM (global system for mobile communications) receiver.

8. The HVAC management system of claim 1, the sensor assembly being Wi-Fi enabled to detect the mobile devices.

9. The HVAC management system of claim 1, the sensor assembly being Bluetooth enabled to detect the mobile devices.

10. The HVAC management system of claim 1, the sensor assembly further comprising at least one additional occupancy detection component for detection based on at least one of light sensing, carbon dioxide sensing, vibration sensing, indoor air quality sensing, toxic gas sensing and smoke sensing.

11. A method of managing a heating, ventilation and air conditioning (HVAC) system comprising:
controlling an atmospheric condition of a space with a plurality of air manipulation components;
approximating a number of occupants present in the space based on a number of mobile devices located within the space with a sensor assembly, wherein approximating the number of occupants comprises detecting communication data associated with a mobile device with a receiver of the sensor assembly;
measuring a temperature of an area of the space proximate the sensor assembly with a temperature sensor of the sensor assembly;
sending data comprising the temperature measured and the number of mobile devices from the sensor assembly to a controller in operative communication with the sensor assembly and the plurality of air manipulation components; and
controlling the plurality of air manipulation components with the controller based on the data received from the sensor assembly.

12. The method of claim 11, wherein the sensor assembly is in wired communication with the controller.

13. The method of claim 12, wherein the sensor assembly is plugged into a power outlet of the space to establish the wired communication.

14. The method of claim 11, wherein the sensor assembly is in wireless communication with the controller.

15. The method of claim 11, wherein the receiver comprises a GSM (global system for mobile communication) receiver.
